(19) United States
(12) Patent Application Publication
(10) Pub. No.: US 2018/0225988 A1
(43) Pub. Date: Aug. 9, 2018

(54) SIGN LANGUAGE GESTURE DETERMINATION SYSTEMS AND METHODS

(71) Applicant: Google LLC, Mountain View, CA (US)

(72) Inventor: Joaquim Morgado, Paris (FR)

(21) Appl. No.: 15/426,286

(22) Filed: Feb. 7, 2017

(51) Int. Cl. G09B 21/02; A41D 1/00; A41B 1/08

(52) U.S. Cl. CPC G09B 21/02; A41B 1/08; A41D 1/005

(57) ABSTRACT

A computer-implemented method and a system for sign language gesture determination can utilize an arm sensor system comprising a conductive thread array woven into an arm region of an article of clothing worn by a user, the arm sensor system being configured to capture arm movement information indicative of movement of an arm of the user, a radio frequency (RF) transceiver worn by the user and configured to capture hand movement information indicative of movement of a hand of the user, and a computing device configured to receive the arm movement information from the arm sensor system, receive the hand movement information from the RF transceiver, determine sign language gestures based on the received arm and hand movement information, obtain a text corresponding to the sign language gestures, and generate an output based on the obtained text.

### FIELD

The present disclosure generally relates to gesture recognition and, more particularly, to a sign language gesture determination systems and methods.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Sign language involves the use of hand and arm gestures having specific meanings as a non-acoustic method of communication for the hearing impaired. Sign language, however, is typically not understood outside of the hearing impaired community, which comprises approximately 360 million people worldwide. Systems have been developed that translate these hand and arm gestures into text or speech.

Conventional sign language gesture determination systems typically utilize special gloves and/or arm bands, which are heavy/bulky and can also have exposed wiring. Examples of such conventional systems are illustrated in FIGS. 1A-1B. As can be seen, these conventional systems are not comfortable to wear and are not visually appealing to the hearing impaired wearer or other users.

### SUMMARY

According to one aspect of the present disclosure, a computer-implemented method is presented. In one implementation, the computer-implemented method can comprise receiving, by a computing device, arm movement information captured by an arm sensor system, the arm sensor system comprising a conductive thread array that is woven into an arm region of an article of clothing worn by a user, the arm movement information being indicative of movement of an arm of the user; receiving, by the computing device, hand movement information captured by a radio frequency (RF) transceiver worn by the user, the hand movement information being indicative of movement of a hand of the user; based on the received arm and hand movement information, determining, by the computing device, sign language gestures; obtaining, by the computing device, a text corresponding to the sign language gestures; and generating, by the computing device, an output based on the obtained text.

In some implementations, the conductive thread array comprises one or more conductive threads that are sewn along with non-conductive threads to form the article of clothing. In some implementations, the arm sensor system further comprises (i) electronics attached to the article of clothing and (ii) wiring connecting the electronics to the conductive thread array. In some implementations, the electronics are configured to measure, via the wiring, a set of signals from the conductive thread array, the set of signals being indicative of the physical displacement of the conductive thread array, and the arm movement information is determined based on the set of signals.

In some implementations, the RF transceiver is not in physical contact with the hand of the user. In some implementations, the article of clothing is a long sleeved shirt and the RF transceiver is attached to or proximate to a cuff of the long sleeved shirt. In some implementations, the RF transceiver is further configured to output RF waves and capture reflected RF waves that are reflected by the hand of the user, and the hand movement information is determined based on the captured reflected RF waves. In some implementations, the RF transceiver further comprises additional electronics configured to determine the hand movement information based on the captured reflected RF waves.

In some implementations, the computing device is configured to utilize a gesture determination model in determining the sign language gestures from the arm and hand movement information. In some implementations, the gesture determination model is machine-trained, and the gesture determination model is adjusted based on past sign language gesture activity by the user.

According to another aspect of the present disclosure, a system is presented. In one implementation, the system can comprise an arm sensor system comprising a conductive thread array woven into an arm region of an article of clothing worn by a user, the arm sensor system being configured to capture arm movement information indicative of movement of an arm of the user; an RF transceiver worn by the user and configured to capture hand movement information indicative of movement of a hand of the user; and a computing device configured to: receive, from the arm sensor system, the arm movement information; receive, from the RF transceiver, the hand movement information; based on the received arm and hand movement information, determine sign language gestures; obtain a text corresponding to the sign language gestures; and generate an output based on the obtained text.

In some implementations, the conductive thread array comprises one or more conductive threads that are sewn along with non-conductive threads to form the article of clothing. In some implementations, the arm sensor system further comprises (i) electronics attached to the article of clothing and (ii) wiring connecting the electronics to the conductive thread array. In some implementations, the electronics are configured to measure, via the wiring, a set of signals from the conductive thread array, the set of signals being indicative of the physical displacement of the conductive thread array, and the arm movement information is determined based on the set of signals.

In some implementations, the RF transceiver is not in physical contact with the hand of the user. In some implementations, the article of clothing is a long sleeved shirt and the RF transceiver is attached to or proximate to a cuff of the long sleeved shirt. In some implementations, the RF transceiver is further configured to output RF waves and capture reflected RF waves that are reflected by the hand of the user, and the hand movement information is determined based on the captured reflected RF waves. In some implementations, the RF transceiver further comprises additional electronics configured to determine the hand movement information based on the captured reflected RF waves.

In some implementations, the computing device is configured to utilize a gesture determination model in determining the sign language gestures from the arm and hand movement information. In some implementations, the gesture determination model is machine-trained, and wherein the gesture determination model is adjusted based on past sign language gesture activity by the user.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A-1B illustrate example sign language gesture determination systems according to the prior art;

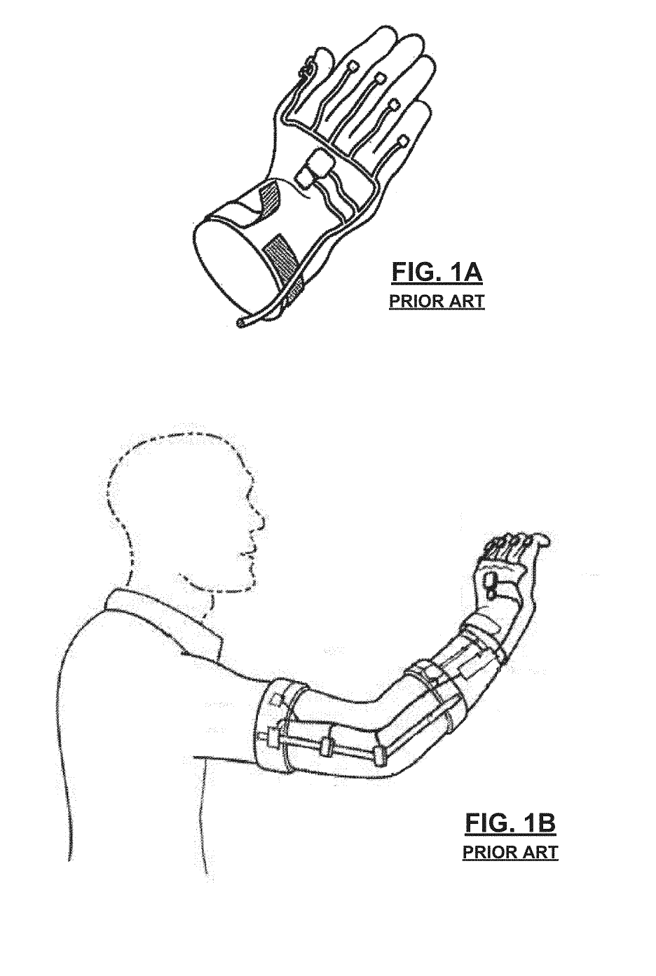

FIG. 2 illustrates an example sign language gesture determination system according to some implementations of the present disclosure;

FIG. 3 illustrates a functional block diagram of the example sign language gesture determination system of FIG. 2;

FIGS. 4A-4D illustrate example user interfaces displayed on a computing device of the example sign language gesture determination system of FIG. 2; and

FIG. 5 illustrates a flow diagram of an example method of determining sign language gestures according to some implementations of the present disclosure.

### DETAILED DESCRIPTION

As mentioned above, conventional sign language gesture determination systems are bulky/heavy and are visually unappealing to wearers and other users. Accordingly, improved sign language gesture determination systems and methods are presented. The sign language gesture determination systems and methods of the present disclosure utilize two types of devices that are incorporated into an article of clothing worn by a hearing impaired user. One example of the article of clothing is a long sleeved shirt, but it will be appreciated that the systems and methods herein could be incorporated into any suitable article of clothing and modified such that arm and/or hand movement information can be captured.

One of the devices comprises an arm sensor system comprising a conductive thread array. The conductive threads of the conductive thread array can be woven into an arm region (e.g., a sleeve) or another suitable portion of the article of clothing. Movement of an arm of the user can be captured by the arm sensor system and transmitted to her/his computing device (e.g., a mobile phone). The term “conductive thread array” can refer to a plurality of conductive threads and, optionally, other electronics (a processor, a memory, etc.) configured to determine the arm movement information from a set of signals measured by the arm sensor system the conductive threads. The specific operation of the arm sensor system and the conductive thread array is discussed in greater detail below.

The other of the two devices comprises a radio frequency (RF) transceiver. The term “RF transceiver” can refer to one or more RF transceivers and, optionally, other electronics (a processor, a memory, etc.) configured to determine the hand movement information indicative of movement of a hand of the user. Specifically, the movement of the hand of the user can be captured by the RF transceiver in the form of reflected RF waves. The RF transceiver can be worn by the user, but may or may not be part of the article of clothing. In one implementation, the RF transceiver can be attached to the article of clothing proximate to but not in direct contact with a hand of the user. One example location for the RF transceiver is a cuff of a long sleeved shirt, such as a dress shirt.

While the RF transceiver may be attached to or otherwise incorporated into the article of clothing (e.g., in a special pocket), the RF transceiver could also be incorporated into other wearables. These wearables can be non-computing wearables (jewelry, such as a necklace, a bracelet, or a button/pin, non-computing eyewear, a non-computing watch, etc.) and computing wearable devices (computing eyewear or eyewear including a computer, a computing watch or “smartwatch,” a fitness wristband or step counter computing device, etc.). Any other suitable non-computing and computing wearables could also be used. By incorporating the RF transceiver into another wearable (i.e., not the article of clothing), the user can utilize the wearable with different conductive thread-equipped articles of clothing, which could save her/him costs compared to a separate RF transceiver for each conductive thread-equipped article of clothing. The specific operation of the RF transceiver is discussed in greater detail below.

In addition to providing very accurate capturing of arm and hand movement information, which results in improved sign language gesture determination, the disclosed systems and methods are not bulky/heavy and are not readily visible to the hearing impaired wearer or other users. The computing device can be configured to communicate with the arm movement sensor and the RF transceiver via a wireless communication protocol (e.g., Bluetooth), but it will be appreciated that any suitable communication medium could be utilized. It will also be appreciated that, in some implementations, the arm sensor system and the RF transceiver could be in direct (e.g., wired) communication. In such an implementation, only one wireless transmitted could be utilized to transmit the arm and hand movement information to the computing device.

Once the computing device receives the arm and hand movement information, it can determine sign language gestures corresponding to the arm and hand movement information. This processing can be performed at the computing device, at one or more remote servers, or some combination thereof. Some of this processing can also be performed at the arm sensor system and/or the RF transceiver. The computing device can execute an application configured to display text (e.g., on its display or another display), obtain a text-to-speech conversion and output an audio signal (e.g., via its speaker or another speaker), obtain a translation of the text, or some combination thereof.

In addition to the performance benefits described above, there are other benefits to the disclosed systems/methods. First, there are no additional devices or components that need to be physically attached to and worn by, compared to conventional components such as gloves and arm bands. Instead, the user need only put on the article of clothing, which is part of a daily routine. Thus, the technical effect of these systems and method may be described as accurate sign language gesture determination using a user's existing computing device (e.g., mobile phone) and a specially-equipped article of clothing, without the need for heavy/bulky components that are visible to other users.

In addition to being visible, these heavy/bulky conventional components may cause other problems. If the user is wearing a long sleeve shirt, such as in colder weather, it may be difficult to roll up her/his sleeves to attach the arm bands to her/his arms or to attach the arm bands over the shirt sleeves. Similarly, the user could be precluded from wearing a pair of gloves in colder weather because special gesture recognition gloves may need to be worn. In warmer weather, the heavy/bulky arm bands and/or gloves may also be rather uncomfortable.

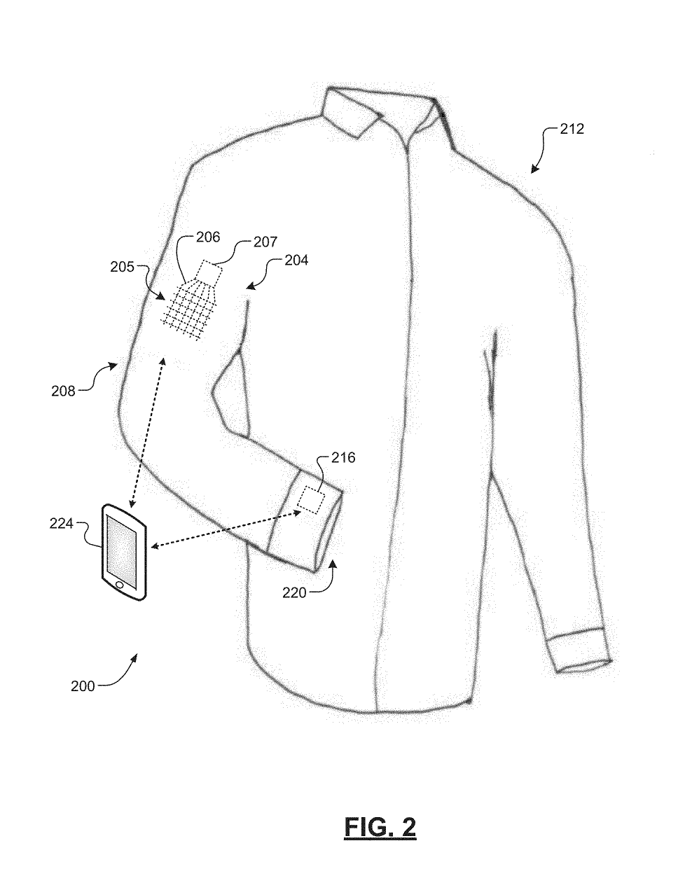

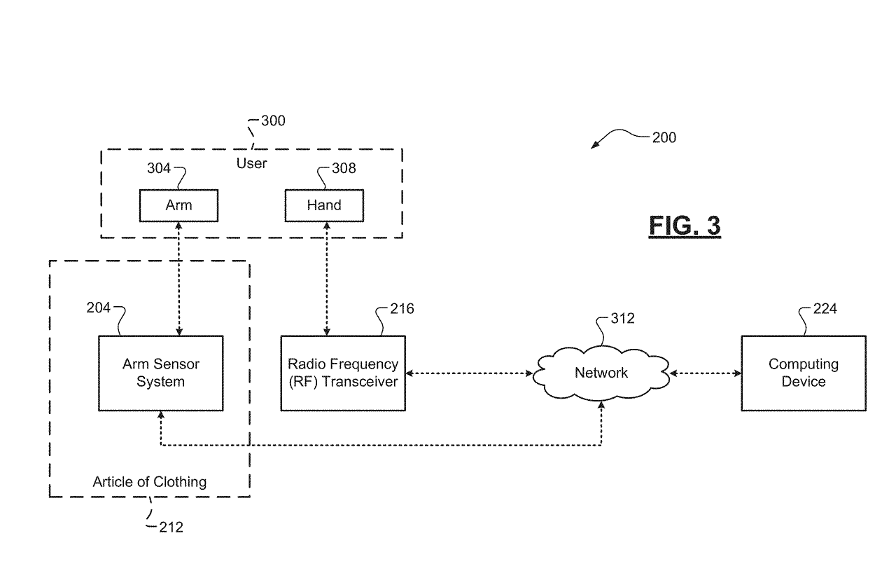

Referring now to FIGS. 2-3, an example sign language gesture determination system 200 is illustrated. In one example implementation, the system 200 can include an arm sensor system 204 comprising a conductive thread array 205 that is sewn into an arm region 208 of a garment or an article of clothing 212. While a long sleeved dress shirt is shown, it will be appreciated that the conductive thread array 205 could be sewn into an arm region of any suitable article of clothing, e.g., a dress. The term “arm region” refers to any point along an arm 304 of a user 300 that is suitable for capturing arm movement information for sign language gesture determination. The conductive thread array 205 can include one or more conductive threads that are sewn, along with normal non-conductive threads, to form the complete article of clothing 212.

The arm sensor system 204 can further include other components, such as connectors or wiring 206 for communicating with the conductive thread array 205 and other electronics 207, such as a small circuit or computing device (e.g., the size of a button on a jacket). As shown, the electronics 207 can measure, via the wiring 206, a set of signals from the conductive thread array 205 and can determine arm movement information therefrom. Each of these signals represents an electrical signal (e.g., a current or a voltage) indicative of a degree of displacement of the particular conductive thread, either with respect to a base displacement or with respect to other conductive thread(s). A higher measurement could be indicative of a greater displacement, or vice versa.

While a single arm sensor system 204 is shown, it will be appreciated that the arm region 208 could include two or more conductive thread arrays. Additionally, while only shown with respect to one arm of the user 300, it will be appreciated that the system 200 can include additional conductive thread array(s) and/or full arm sensor system(s) for sensing the other arm of the user 300. It will also be appreciated that a portion of the arm sensor system 204 could be removed and therefore could be shared across multiple conductive thread-equipped articles of clothing. For example, the electronics 207 may be removable connectable or coupled to the wiring 206 (e.g., via a connector or wire harness). In this manner, the electronic 207 (e.g., a small chip or computing device) could be disconnected or decoupled from the wiring 206 and then utilized with another conductive thread-equipped article of clothing by connecting or coupling the electronics 207 to a corresponding wiring/connector/wire harness of the other conductive thread-equipped article of clothing. This could save the user 300 costs by not needing separate electronics 207 for each conductive thread-equipped article of clothing.

Each conductive thread can comprise thin, metallic alloys along with natural and/or synthetic thread(s), such as cotton, polyester, and silk. Different colors/compositions of the conductive thread can be mass produced and stored on spools, which can then be accessed during clothing fabrication. The inclusion of natural/synthetic threads can make the conductive thread strong enough to be woven on industrial sewing equipment, such as an industrial loom. Example configurations of the conductive thread array 205 include a single conductive thread, a plurality of parallel conductive threads, and a plurality of perpendicular conductive threads, and combinations thereof. For example, a touch or gesture-sensitive area could include one or more sets of overlapping conductive threads that each extend across an entire width or height of the area, also known as a cross-hatch pattern. Alternatively, for example, a sensor grid could include a plurality of points where the conductive thread appears on an outer surface of the grid and the article of clothing, and the remainder of each conductive thread can be sewn into an inner surface of the article of clothing or behind the grid.

The system 200 can also include an RF transceiver 216 attached to the article of clothing 212 at a location 220 proximate to a hand 308 of the user 300. One example location 220 for the RF transceiver 216 is a cuff of the article of clothing 212 (a long sleeved shirt, a dress, etc.), but it will be appreciated that the RF transceiver 216 could be attached to the article of clothing 212 at any suitable location for transmitting RF waves towards the hand 308 of the user 300 and capturing reflected RF waves that are reflected by the hand 308 of the user 300, e.g., any proximate location that is spaced apart from or that is not in direct physical contact with the hand 308 of the user 300. The term “attached” refers to any suitable manner by which the RF transceiver 216 is affixed to the article of clothing 212 (sewn to, glued to, sewn into a pocket or cavity, etc.). In some implementations, the RF transceiver 216 can transmit/receive RF waves through a portion of the article of clothing 212, but it will be appreciated that the RF transceiver 216 could also have a clear path of transmission/reception with respect to the hand 308 of the user 300. Similar to the arm sensor system 205, it will be appreciated that multiple RF transceivers could be implemented in one or both hand regions of the article of clothing 212.

A transmitter portion of the RF transceiver 216 transmit or emit low-power electromagnetic (e.g., RF) waves in a broad beam (e.g., a 60 gigahertz (GHz) industrial, scientific, and medical radio (ISM) band). By emitting in a broad beam, a broader area of hand movement can be captured. Objects (e.g., a hand) within the emitted beam scatter the RF waves, thereby reflecting some portion of the RF waves back towards a receiver or antenna portion of the RF transceiver 216. Properties of the reflected signal, such as energy, time delay, and frequency shift are each indicative of information about the object's characteristics and dynamics. Non-limiting examples of these characteristics and dynamics include size, shape, orientation, material, distance, and velocity. The RF transceiver 216 can also operate at a relatively low bandwidth and spatial resolution. This can be accomplished by identifying or extracting very subtle changes in the reflected RF waves over time. By processing these temporal signal variations, the RF transceiver 216 can distinguish complex finger movements and deforming hand shapes.

As previously mentioned, the term “RF transceiver” can further include other components, such as a computing device for performing at least a portion of the hand movement information determination. Similar to the arm sensor system 204, it will be appreciated that at least a portion of the hand movement information determination could be performed away from the RF transceiver 216, such as at the computing device 224 or at a remote server. The hand movement information determination may be hardware agnostic and therefore may be capable of working with different types of radar (Frequency Modulated Continuous Wave (FMCW) radar, Direct-Sequence Spread Spectrum (DSSS) radar, etc.). The determination process can include several stages of abstraction, from the raw reflected RF wave data to signal transformations, core and abstract machine learning features, detection and tracking, gesture probabilities, and tools to interpret gesture controls. Similar to the arm sensor system 204, machine-learning techniques can be utilized to train a hand movement model, and the hand movement model can be used to determine the hand movement information based on the reflected RF waves.

The system 200 can further include a computing device 224. While a mobile phone is illustrated, it will be appreciated that the computing device 224 could be any other suitable type of devices (a tablet computer, a laptop computer, a desktop computer, a home automation computing device, a wearable computing device, such as smart glasses or a smart watch incorporating a computer, etc.). The computing device 224 can communicate with both arm sensor system 204 and the RF transceiver 216 via a network 312. The network 312 can include a local area network (LAN), a wide area network (WAN), e.g., the Internet, or combinations thereof. In one example implementation, the network 312 is a short-range wireless communication network, such as Bluetooth. It will be appreciated, however, that other short-range wireless communication networks could be utilized (near field communication (NFC), WiFi Direct, etc.). As discussed in greater detail below, a pairing process may be performed during which communication is established between the computing device 224 and these devices 204 and/or 216.

The computing device 224 can execute a software application that can establish communication with the arm sensor system 204 and the RF transceiver 216 and, using the captured arm/hand movement information, can then perform the gesture determination and other related tasks (text-to-speech, translation, etc.). The sign language gesture determination can utilize machine-learning techniques to determine specific sign language gestures from various combinations of arm and hand movement information. For example, the hand movement information may be indicative of two possible sign language gestures, but the arm movement information may be indicative of a particular one of the two possible sign language gestures. Machine-learning techniques may be utilized to train arm and/or hand movement models, which can be utilized to determine the arm and hand movement information from the measured set of signals from the conductive thread array 205 and the reflected RF waves, respectively.

Machine-learning techniques can also be utilized to train a gesture determination model, which can then be utilized to determine the sign language gestures based on the arm and hand movement information. Each of the models discussed herein can be a probabilistic model that utilizes various parameters for determining a most-likely output (arm movement information, hand movement information, or sign language gesture). For example, the measured set of signals from the conductive thread array 205 may be input to the arm movement model to determine a particular arm angle, which could be indicative of particular sign language gestures. Additionally, for example, the reflected RF waves could be input to the hand movement model to determine a particular hand angle or shape, which could be indicative of particular sign language gestures. Similarly, the arm and hand movement information could be input to the gesture determination model to determine a most-likely sign language gesture.

By utilizing machine-learning techniques, sign language gesture determination accuracy can be increased. Optionally, some of all of the models discussed above could be adjusted or otherwise adapted over time specifically for the user 300, because every user may perform their sign language gestures slightly differently. This adjustment process could be based, for example, based on feedback from the user 300. For example, the user 300 may repeatedly provide feedback that a particular sign language gesture determination is incorrect, which could be due to, for example, the user 300 utilizing a slightly different than average arm angle when signing a particular sign language gesture. In this example, one or both of the arm movement and gesture determination models could be adjusted accordingly.

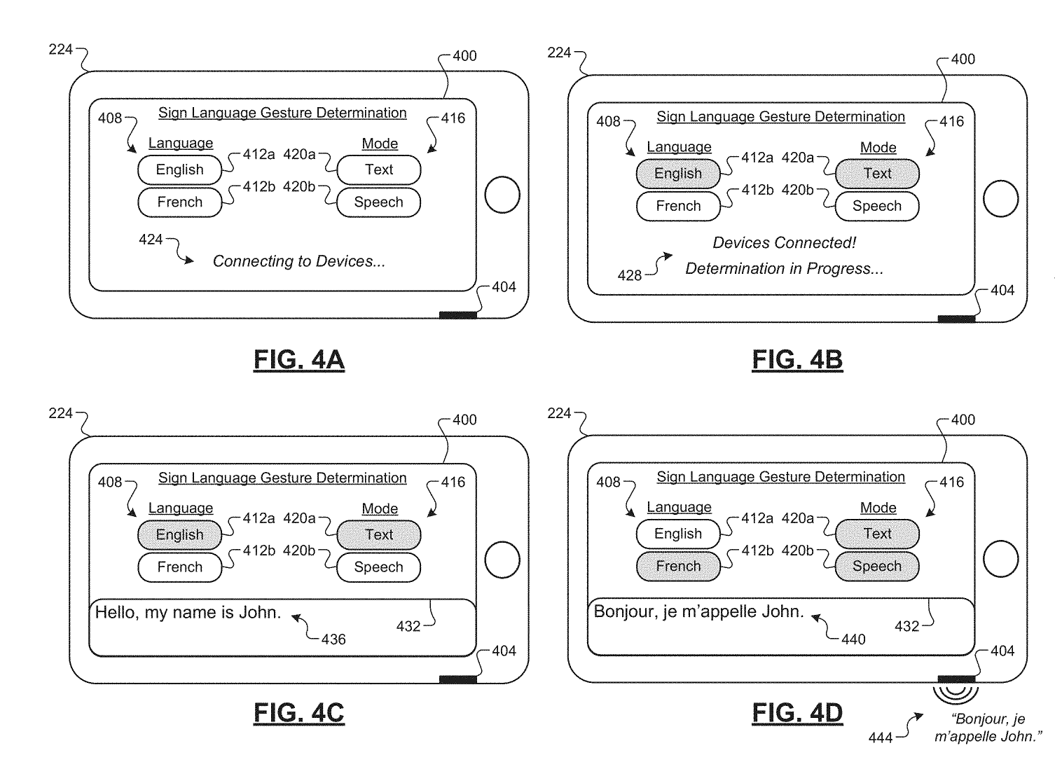

Referring now to FIGS. 4A-4D, example user interfaces displayed by the computing device 224 are illustrated. The user interfaces of FIGS. 4A-4D represent different states of a display 400 (e.g., a touch display) and a speaker 404 of the computing device 224 during the sign language gesture determination process. As mentioned above, the computing device 224 can execute a software application, which is shown as “Sign Language Gesture Determination.” This software application could be launched in response to an input from the user 300, such as a touch input (e.g., selecting an icon corresponding to the software application) or a voice input (e.g., “Ok phone, please launch Sign Language Gesture Determination”).

In each user interface, there is a language menu 408 and a mode menu 416. The language menu 408 comprises two options: English 412a and French 412b. The languages listed in this menu 408 could be previously selected or input by the user 300 or they could be automatically determined based on past activity or a profile of the user 300, e.g., her/his language settings. The mode menu 416 also comprises two options: text mode 420a and speech mode 420b. In FIG. 4A, a status indicator 424 indicates that the computing device 224 is “Connecting to Devices . . . ” e.g., the arm sensor system 204 and the RF transceiver 216.

In FIG. 4B, this connection has been established and the user 300 has selected English 412a and text mode 420a. A status indicator 428 indicates “Determination In Progress . . . ”. This means that the computing device 224 is in the process of receiving the arm/hand movement information from the arm sensor system 204 and the RF transceiver 216 and is determining sign language gestures therefrom. In FIG. 4C, the sign language gesture determination is complete and a text corresponding to the determined gestures has been obtained. As shown in text area 432, the obtained text 436 reads “Hello, my name is John.”

In FIG. 4D, the selected language and modes are different. This change could be input by the user 300 after the state depicted by FIG. 4C or instead of the state depicted by FIG. 4B. As shown, the user 300 has selected French 412b and both text mode 420a and speech mode 420b. As shown in the text area 432, the new obtained text 440 reads “Bonjour, je m′appelle John.” This new obtained text 440 represents an English-to-French translation of the previous obtained text 436 (“Hello, my name is John.”). Because speech mode 420b has also been selected, text-to-speech is also performed and an audio signal is then output by the speaker 404.

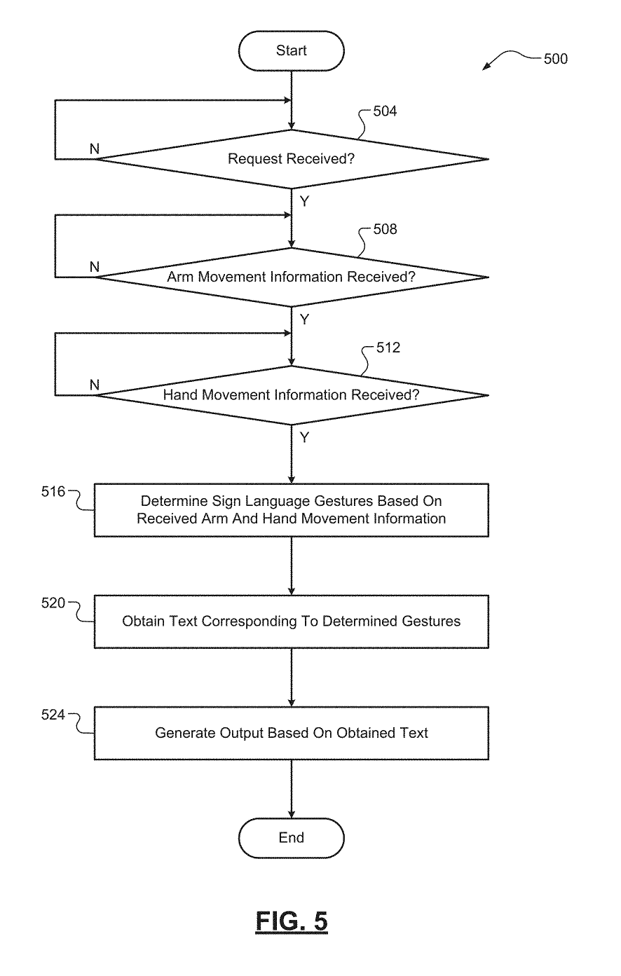

Referring now to FIG. 5, an example method 500 of sign language gesture determination is illustrated. At 504, the computing device 224 determines whether a request has been received. This request can represent the launching of the software application or an input by the user 300 within the software application. Detecting the request could also include determining whether the connection has been established between the computing device 224 and the arm sensor system 204 and the RF transceiver 216. When such a request is detected, the method 500 can proceed to 508. Otherwise, the method 500 can return to 504.

At 508, the computing device 224 can determine whether the arm movement information has been received from the arm sensor system 204. When it has been received, the method 500 can proceed to 512. Otherwise, the method 500 can return to 508. At 512, the computing device 224 can determine whether the hand movement information has been received from the RF transceiver 216. When it has been received, the method 500 can proceed to 516. Otherwise, the method 500 can return to 512. It will be appreciated that the order of 508 and 512 could be reversed or these operations could overlap temporally, i.e., the arm/hand movement information could be received at the same time.

At 516, the computing device 224 can use the arm/hand movement information to determine sign language gestures. This determination can be performed locally at the computing device 224, at a remote server, or some combination thereof. At 520, the computing device 224 can obtain a text corresponding to the determined sign language gestures. For example, the text may vary depending on a type of sign language selected by the user 300, such as American Sign Language (ASL). Again, this text could be obtained locally by the computing device 224, by a remote server, or some combination thereof.

At 520, the computing device 224 can generate an output based on the obtained text. Non-limiting examples of this output include displaying the obtained text, text-to-speech conversion of the obtained text and outputting the resulting audio signal, translating the obtained text, displaying the translated text, text-to-speech conversion of the translated text and outputting the resulting audio signal, and combinations thereof. It will be appreciated that any other suitable outputs could also be generated, such as transmitting a text or an audio signal to another computing device. The method 500 can then end or return to 504 for one or more additional cycles.

Further to the descriptions above, a user may be provided with controls allowing the user to make an election as to both if and when systems, programs or features described herein may enable collection of user information (e.g., information about a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, by a computing device, arm movement information captured by an arm sensor system, the arm sensor system comprising a conductive thread array that is woven into an arm region of an article of clothing worn by a user, the arm movement information being indicative of movement of an arm of the user;
receiving, by the computing device, hand movement information captured by a radio frequency (RF) transceiver worn by the user, the hand movement information being indicative of movement of a hand of the user;
based on the received arm and hand movement information, determining, by the computing device, sign language gestures;
obtaining, by the computing device, a text corresponding to the sign language gestures; and
generating, by the computing device, an output based on the obtained text.

2. The computer-implemented method of claim 1, wherein the conductive thread array comprises one or more conductive threads that are sewn along with non-conductive threads to form the article of clothing.

3. The computer-implemented method of claim 2, wherein the arm sensor system further comprises (i) electronics attached to the article of clothing and (ii) wiring connecting the electronics to the conductive thread array.

4. The computer-implemented method of claim 3, wherein the electronics are configured to measure, via the wiring, a set of signals from the conductive thread array, the set of signals being indicative of the physical displacement of the conductive thread array, wherein the arm movement information is determined based on the set of signals.

5. The computer-implemented method of claim 1, wherein the RF transceiver is not in physical contact with the hand of the user.

6. The computer-implemented method of claim 1, wherein the article of clothing is a long sleeved shirt and the RF transceiver is attached to or proximate to a cuff of the long sleeved shirt.

7. The computer-implemented method of claim 1, wherein the RF transceiver is further configured to output RF waves and capture reflected RF waves that are reflected by the hand of the user, and wherein the hand movement information is determined based on the captured reflected RF waves.

8. The computer-implemented method of claim 7, wherein the RF transceiver further comprises additional electronics configured to determine the hand movement information based on the captured reflected RF waves.

9. The computer-implemented method of claim 1, wherein the computing device is configured to utilize a gesture determination model in determining the sign language gestures from the arm and hand movement information.

10. The computer-implemented method of claim 9, wherein the gesture determination model is machine-trained, and wherein the gesture determination model is adjusted based on past sign language gesture activity by the user.

11. A system, comprising:
an arm sensor system comprising a conductive thread array woven into an arm region of an article of clothing worn by a user, the arm sensor system being configured to capture arm movement information indicative of movement of an arm of the user;
a radio frequency (RF) transceiver worn by the user and configured to capture hand movement information indicative of movement of a hand of the user; and
a computing device configured to:
receive, from the arm sensor system, the arm movement information;
receive, from the RF transceiver, the hand movement information;
based on the received arm and hand movement information, determine sign language gestures;
obtain a text corresponding to the sign language gestures; and
generate an output based on the obtained text.

12. The system of claim 11, wherein the conductive thread array comprises one or more conductive threads that are sewn along with non-conductive threads to form the article of clothing.

13. The system of claim 12, wherein the arm sensor system further comprises (i) electronics attached to the article of clothing and (ii) wiring connecting the electronics to the conductive thread array.

14. The system of claim 13, wherein the electronics are configured to measure, via the wiring, a set of signals from the conductive thread array, the set of signals being indicative of the physical displacement of the conductive thread array, wherein the arm movement information is determined based on the set of signals.

15. The system of claim 11, wherein the RF transceiver is not in physical contact with the hand of the user.

16. The system of claim 11, wherein the article of clothing is a long sleeved shirt and the RF transceiver is attached to or proximate to a cuff of the long sleeved shirt.

17. The system of claim 11, wherein the RF transceiver is further configured to output RF waves and capture reflected RF waves that are reflected by the hand of the user, and wherein the hand movement information is determined based on the captured reflected RF waves.

18. The system of claim 17, wherein the RF transceiver further comprises additional electronics configured to determine the hand movement information based on the captured reflected RF waves.

19. The system of claim 11, wherein the computing device is configured to utilize a gesture determination model in determining the sign language gestures from the arm and hand movement information.

20. The system of claim 19, wherein the gesture determination model is machine-trained, and wherein the gesture determination model is adjusted based on past sign language gesture activity by the user.
